(19) United States
(12) Patent Application Publication
(10) Pub. No.: US 2025/0272733 A1
(43) Pub. Date: Aug. 28, 2025

(54) Computer-Implemented Method For Trading Yarn Packages

(71) Applicant: Uster Technologies AG, Uster (CH)

(72) Inventors: Isik TIRAMIS, Uster (CH); Serap DÖNMEZ KRETZSCHMAR, Lachen (CH); Martin NORDIO, Zurich (CH); Jia TAN, Suzhou (CN); Jian GAO, Jingjiang City (CN)

(73) Assignee: Uster Technologies AG, Uster (CH)

(21) Appl. No.: 18/858,311

(22) PCT Filed: Apr. 19, 2023
(86) PCT No.: PCT/IB2023/000136

§ 371 Date: Oct. 19, 2024

(30) Foreign Application Priority Data
Apr. 21, 2022 (CN) 202210422804.5

(51) Int. Cl. G06Q 30/0601; B65H 63/00; G06Q 40/04

(52) U.S. Cl. CPC G06Q 30/0627; B65H 63/006; G06Q 40/04

(57) ABSTRACT

The computer-implemented method serves for efficiently trading yarn packages. A server computer system receives from a spinning mill having produced a yarn package a set of measured values for yarn-quality parameters measured for yarn on the yarn package and further information on the yarn package. It assigns a package identifier to the set of measured values and to the further information and stores them in a database. The server computer system receives from a client computer purchase request containing yarn specifications. It retrieves from the database sets of yarn packages such that the further information matches the yarn specifications for all packages of each set. It produces a ranking of the sets of yarn packages according to the sets of measured values. It transmits to the client computer information on sets of yarn packages best ranked in the produced ranking.

### FIELD OF THE INVENTION

The present invention lies in the fields of yarn production, yarn-quality determination and yarn trading. It relates to a computer-implemented method and a server computer system for trading yarn packages, according to the independent patent claims.

### DESCRIPTION OF THE PRIOR ART

WO-2019/227241 A1 discloses a method for operating a ring spinning system which contains a ring spinning machine with a plurality of spinning positions and a winding machine with a plurality of winding positions. Yarn spun on the spinning machine is transported on cops to the winding machine. There, it is wound from the cop onto a larger yarn package. Values of yarn parameters are determined by a yarn clearer during the winding process on the winding machine and stored as yarn data.

EP-0′854′107 A1 discloses a yarn-package grade determination system. The system comprises a yarn quality monitoring means such as a tension controller provided for each unit in a draw texturing machine to constantly monitor data on the quality of yarn processed into packages, a transfer means for transferring packages ejected from the machine to the exterior while identifying the sources of the packages, an inspection means for inspecting, at least, weight or appearance of the package transferred by the transfer means, and a grade determination means for combining data on each package from the yarn quality monitoring means with data on each package from the inspection means to determine the grade of the package. The grades are used for the processing of the packages within the draw texturing machine factory.

CN-110′033′350 A discloses a textile fabric mobile internet transaction platform which comprises an online server, and an application program end, a direct marketing end and a big database which are in communication connection with the online server. The application program end is at least integrated with a supply module and a purchasing module. The basic parameter information of the fabric product is uploaded to an online server, and a unique two-dimensional code is generated. The purchasing module is used for providing classification service, retrieval service and purchasing service for the purchaser. The direct marketing end comprises a fabric offline warehouse for placing and attaching a label. The big database stores the data generated in the operation process of the platform in a classified manner. The online server provides the data interaction and synchronization and pushes different contents according to the trend of the data.

In order to compare the quality level of one textile mill with another's, a common “quality language” is needed. Worldwide accepted quality benchmarks or quality references in the textile industry are the USTER® STATISTICS; see USTER® NEWS BULLETIN Nos. 49 and 51, Uster Technologies AG, November 2012 and October 2018, respectively. The USTER® STATISTICS are a comprehensive statistical survey of the quality of textile materials produced worldwide. They essentially contain statistical data in the form of graphs with percentile curves for numerous parameters and textile materials. These graphical cumulative frequency representations statistically indicate the extent by which a certain textile material is above or below a certain quality-parameter value. For instance, a percentile value of 25 means that 25% of the textile mills worldwide produce the respective product with the same or lower value of the respective quality parameter. Numerical editions, as opposed to graphical, are also available. The USTER® STATISTICS are made available by Uster Technologies AG via the internet (https://www.uster.com/value-added-services/uster-statistics/).

Yarn is bought from spinning mills mainly by weaving and knitting mills. Yarn buyers want to source yarn efficiently in the right amount and quality for their downstream application. However, they are often faced with numeric yarn parameters which they do not fully understand, nor do they understand their impact on the end application. Nowadays, before buying a large batch of yarn packages, they first buy a small sample of packages of a certain yarn type, for which they make acceptance trials. This is time and cost intensive, and, moreover, unreliable due to the small sample size. Sometimes yarn packages or whole lots have to be returned due to their unsatisfactory quality, and sometimes orders are not placed due to disappointing trial results.

### SUMMARY OF THE INVENTION

It is an object of the present invention to provide the technical infrastructure that avoids the drawbacks of the prior art and thus facilitates an efficient and more environmentally friendly trading of yarn packages. The computer-implemented method and server computer system shall make costly and lengthy acceptance trials obsolete. With no or less acceptance trials, less samples have to be transported and less material is wasted. The invention shall allow yarn buyers to purchase exactly the quality needed. Wasted shipping of yarn-package samples and/or whole yarn-package lots shall be avoided.

These and other objects are solved by the computer-implemented method and server computer system as defined in the independent claims. Advantageous embodiments are specified in the dependent claims.

The computer-implemented method according to the invention is for trading yarn packages produced on yarn-winding machines in at least one spinning mill. The method comprises the steps of: receiving by a server computer system via a global communication network from a spinning mill having produced a yarn package on a yarn-winding machine a set of measured values for at least one yarn-quality parameter measured for yarn on the yarn package by at least one sensor on the yarn-winding machine and further information on the yarn package; assigning by the server computer system to the set of measured values and to the further information a package identifier for the respective yarn package; storing in a database on the server computer system the set of measured values, the further information and the assigned package identifier; receiving by the server computer system via a global communication network from a client computer a purchase request containing yarn specifications; retrieving from the database, using the package identifiers, sets of yarn packages such that the further information matches the yarn specifications for all packages or each of the retrieved sets of yarn packages; producing by the server computer system a ranking of the retrieved sets of yarn packages according to the sets of measured values assigned to the yarn packages of each set of yarn packages; and transmitting from the server computer system via the global communication network to the client computer information on a natural number of sets of yarn packages best ranked in the produced ranking.

According to one embodiment of the invention, the set of measured values is for at least one parameter from the following set: coefficient of variation of the yarn mass, coefficient of variation of the yarn diameter, hairiness, number of thick places, number of thin places, number of periodic yarn defects, number of yarn count variations, number of foreign matters, number of splices.

According to one embodiment of the invention, the further information is from the following set: yarn count, yarn material, fiber processing system, spinning system, envisaged application, amount of yarn packages available, temporal availability of the yarn package, price of the yarn package.

According to one embodiment of the invention, the yarn specifications are from the following set: yarn count, yarn material, fiber processing system, spinning system, envisaged application, desired amount.

According to one embodiment of the invention, the database is a relational database, the package identifier is assigned biuniquely to each set of measured values and to each further information, and the package identifier is used as a key in the relational database.

According to one embodiment of the invention, the ranking is produced on an ordinal scale or on a metric scale.

According to one embodiment of the invention, the ranking is in the form of values calculated from the sets of measured values, in the form of quantiles or percentiles assigned to the sets of yarn packages, in the form of ordinal numbers assigned to the sets of yarn packages, and/or in the form of classes into which the sets of yarn packages are classified.

According to one embodiment of the invention, the ranking takes into account a mean value of each of the yarn-quality parameters calculated over the whole set of yarn packages.

According to one embodiment of the invention, the natural number of best-ranked sets of yarn packages is higher than one and lower than the number of retrieved sets of yarn packages.

According to one embodiment of the invention, an order is received by the server computer system via the global communication network from the client computer, the order identifying a chosen set or sets of yarn packages and indicating an ordered amount. Upon receipt of the order, the server computer system can forward the order to the spinning mill that produced the ordered set of yarn packages.

One embodiment of the invention further comprises the steps of: receiving by the server computer system via the global communication network from the spinning mill values of at least one ambient parameter characteristic for an ambient condition of a location and a time of winding the yarn package; correcting by the server computer system the set of measured values to predefined ambient conditions based on the values of the at least one ambient parameter, thus generating a set of corrected values; and replacing in the methods according to the invention as described above the set of measured values by the set of corrected values.

According to one embodiment of the invention, the yarn packages are produced in a plurality of spinning mills, and the method further comprise the steps of: assigning by the server computer system to the set of measured values and to the further information a mill identifier for the respective spinning mill; storing in the database the assigned mill identifier; and retrieving from the database, using the mill identifiers, the sets of yarn packages such that all yarn packages of each of the retrieved sets of yarn packages were produced by the same spinning mill.

The invention further encompasses a server computer system comprising means for carrying out one of the methods according to the invention as described above.

The invention also encompasses a computer program having instructions which when executed by a server computer system cause the server computer system to perform one of the methods according to the invention as described above.

The server computer system according to the invention is for trading yarn packages produced on yarn-winding machines in at least one spinning mill. The server computer system comprises: a receiver for receiving via a global communication network from a spinning mill having produced a yarn package on a yarn-winding machine a set of measured values for at least one yarn-quality parameter measured for yarn on the yarn package by at least one sensor on the yarn-winding machine, and for receiving via the global communication network from the spinning mill further information on the yarn package; a processor for assigning to the set of measured values and to the further information a package identifier for the respective yarn package; a memory for storing in a database the set of measured values. the further information and the assigned package identifier; a receiver for receiving via a global communication network from a client computer a purchase request containing yarn specifications; a processor for retrieving from the database, using the package identifiers, at least one set of yarn packages such that the further information matches the yarn specifications for all packages of each of the sets of yarn packages; a processor for producing a ranking of the retrieved sets of yarn packages according to the sets of measured values assigned to the yarn packages of each set of yarn packages; and a transmitter for transmitting via the global communication network to the client computer information on at least the set of yarn packages best ranked in the produced ranking.

The “set of measured values” can consist of any natural number of measured values including one.

In this document, an “ordinal scale” is a variable measurement scale used to simply depict the order of variables and not the difference between each of the variables. A “metric scale” is a variable measurement scale that not only produces the order of variables but also makes the difference between variables known. The term “metric scale” can be subdivided into an “interval scale”, which does not indicate any zero point, and a “ratio scale”, which additionally provides information on the value of true zero.

In this document, the term “yarn-winding machine” or “winding machine” denotes any machine in a spinning mill that winds yarn onto a yarn package larger than a cop. In the ring-spinning process, this is typically a stand-alone winding machine. In spinning processes other than ring spinning (e.g., compact, rotor or air-jet spinning), the spun yarn is wound directly onto a yarn package on the spinning machine. Such spinning machines other than ring-spinning machines are also referred to as “yarn-winding machines” or “winding machines” in this document.

A “server computer system” as used in this document may consist of several pieces of computer hardware suitably connected for communicating with each other. Such pieces of computer hardware need not necessarily be located at the same site but may rather be distributed over different locations.

A “buyer” as used in this document can be an end user of the yarn, such as a weaving or knitting mill, or any intermediary who resells or conveys the yarn to another buyer. In the latter case, the intermediary need not perform a monetary transaction in the strict sense of buying.

The present invention facilitates an efficient trading of yarn packages. The buyer can make a decision based on objective quality data available for the whole lot to be sourced, instead of only samples used for acceptance trials. Offers are sent to the buyer within a very short period of time—in the range of seconds or minutes—after the buyer dispatching a purchase request. Thus, costly and lengthy acceptance trials are no longer necessary or substantially reduced. Since the yarn-quality parameters of all available yarn packages have been measured and are known, the invention ascertains that all purchased packages fulfill the quality criteria. This allows the yarn buyers to purchase exactly the quality needed. A wasted shipping of yarn-package samples and/or whole yarn-package lots, as well as returns of yarn packages of unsatisfactory quality, are thus avoided or drastically minimized. Insofar, the invention respects the environment.

### BRIEF DESCRIPTION OF THE DRAWINGS

In the following, the invention is explained in detail based on the drawings.

FIG. 1 schematically shows a server computer system according to the invention, together with its environment.

FIG. 2 schematically shows tables of a database implemented in the server computer system according to the invention.

FIG. 3 shows an example of a user interface displayed on a client computer.

### IMPLEMENTATION OF THE INVENTION

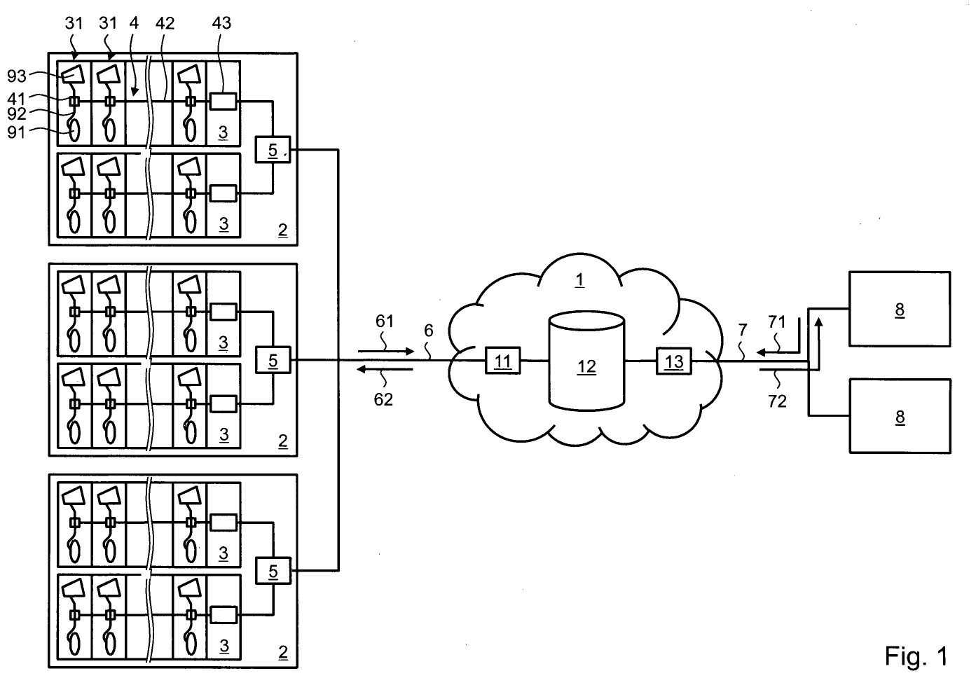

FIG. 1 schematically shows a server computer system 1 according to the invention, together with its environment. The server computer system 1 is preferably realized by means of cloud computing, i.e., employs remote shared computer resources, and is therefore symbolized by a cloud in FIG. 1. The server computer system 1 is connected via a global communication network 6 such as the world wide web with a plurality of spinning mills 2. The server computer system 1 is also connected via a global communication network 7 such as the world wide web with a plurality of client computers 8, each of the client computers 8 being operated by a yarn buyer. Only three spinning mills 2 and two client computers 8 are drawn in FIG. 1 for the sake of simplicity; however, in practice the numbers of spinning mills 2 and client computers 8 can be significantly higher.

For communicating with the spinning mills 2 and the client computers 8, the server computer system 1 is equipped with suitable communication means 11, 13. The communication means 11, 13 include hardware, such as routers, and software, such as application programming interfaces (APIs). They act as a receiver and/or transmitter each.

The spinning mills 2 produce yarns 92. In the ring-spinning process, the spun yarn 92 is wound onto relatively small cops 91. The cops 91 are transported from ring-spinning machines (not shown) to winding machines 3. Each winding machine 3 has a large number of winding positions 31. At each winding position 31, yarn 92 is wound from several cops 91 onto a larger yarn package 93, which is typically a cross-wound bobbin. Alternatively, in spinning processes other than ring spinning, the spun yarn is wound directly onto a yarn package on the spinning machine. Such spinning machines, as well as the stand-alone winding machines 3 used in ring spinning, are referred to as “yarn-winding machines” or “winding machines” in this document.

The winding machine 3 is equipped with a yarn monitoring system 4 for monitoring properties of the yarn 92. The yarn monitoring system 4 can, for example, be designed as a yarn clearing system with a yarn sensor 41 at each of the winding positions 31. The yarn sensor 41 measures values of at least one yarn-quality parameter of the yarn wound on the yarn package. Each yarn sensor 41 is connected to a yarn monitoring control unit 43 via a wired or wireless data line 42. The yarn sensor 41 transmits values of the at least one measured value to the yarn monitoring control unit 43 via the data line 42. The yarn monitoring control unit 43 receives the measured values and stores them together with associated information that identifies the corresponding yarn package 93. Each yarn sensor 41 can be assigned a yarn cutting unit (not drawn) that removes impermissible yarn defects from the yarn 92.

Examples of the yarn-quality parameters are a coefficient of variation of the yarn mass, a coefficient of variation of the yarn diameter, a hairiness, a number of thick places, a number of thin places, a number of periodic yarn defects, a number of yarn count variations, a number of foreign matters and a number of splices. Such yarn-quality parameters can be indicated per unit length of the yarn 92, per unit mass of the yarn 92 and/or per yarn package 93. For the purposes of the present invention, the values of the yarn-quality parameters of the yarn wound on the yarn package 93 are relevant and thus stored. These values generally differ from those of the yarn on the cop 91 due to the yarn-clearing function performed by the yarn-clearing system 4.

Apart from the yarn-quality parameters, further information on the yarn package 93 is used for characterizing the yarn 92 on the yarn package 93. Such further information can be technical and/or non-technical. It may comprise, e.g., the following:
Yarn count, e.g., Ne 20, Ne 30, etc.;
Yarn material, e.g., cotton, polyester, viscose, modal, wool, etc.;
Fiber-processing system, e.g., carding or combing;
Spinning system, e.g., ring-spun yarn, compact yarn, rotor yarn, air-jet yarn, etc.;
Envisaged application, e.g., knitting or weaving;
Amount of yarn 92 on the yarn package 93, e.g., 10 kg or 500 km;
Temporal availability of the yarn 92, e.g., deliverable within one week or within two weeks, etc.;
Price of the yarn 92;
Producer of the yarn 92; and/or
Yarn brand.

The measured values of yarn-quality parameters together with the further information on the yarn package 93 are transmitted from each of the spinning mills 2 via the global communication network 6 to the server computer system 1, which data transmission is indicated by an arrow 61 in FIG. 1. For this purpose, all yarn monitoring control units 43 of the spinning mill 2 can be connected to a cloud connector 5 connected to the server computer system 1 via the global communication network 6. The server computer system 1 receives the values measured for each yarn package 31 as a set of measured values.

The server computer system 1 assigns to the received set of measured values and to the received further information a package identifier for the respective yarn package 93 and a mill identifier for the respective spinning mill 2 that produced the yarn package 93. The package identifier is preferably assigned biuniquely to each received set of measured values and to each received further information. However, in some embodiments of the invention it can be sufficient to assign the same package identifier to sets of measured values for a group of yarn packages 93 presumably having similar properties. The mill identifier is needed only in embodiments with two or more spinning mills 2; in an embodiment with only one spinning mill, it is unnecessary.

The received set of measured values, the received further information, the assigned package identifier and the assigned mill identifier are stored in a database 12 on the server computer system 1.

The spinning mill 2, the winding machine 3 and/or the winding position 31 can be equipped with at least one ambient-condition sensor (not drawn) for sensing ambient conditions of the winding position 31. Examples for ambient parameters measured by such an ambient-condition sensor are an air temperature and an air humidity. Ambient parameter values measured by the at least one ambient-condition sensor are also transmitted from the spinning mill 2 via the global communication network 6 to the server computer system 1. The server computer system 1 can use the measured ambient-parameter values for correcting the received set of values of the yarn-quality parameters to predefined ambient conditions, e.g., normal conditions, thus producing a set of corrected values. Such a correction makes the values of the yarn-quality parameters measured at different locations and/or at different times comparable to each other. The corrected set of measured values is stored in the database 12 on the server computer system 1 together with the further information, the assigned package identifier and the assigned mill identifier, instead of or in addition to the originally received set of measured values. In the method according to this embodiment, the set of corrected values replaces the set of measured values. Hence, in the present description, the term “measured values” can be replaced by “corrected values”, unless otherwise specified.

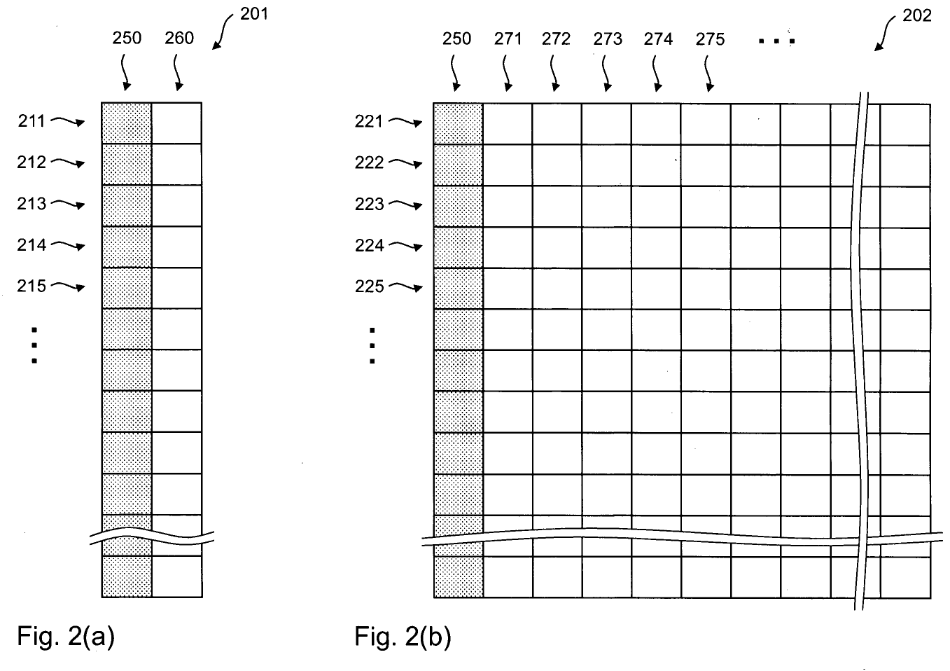

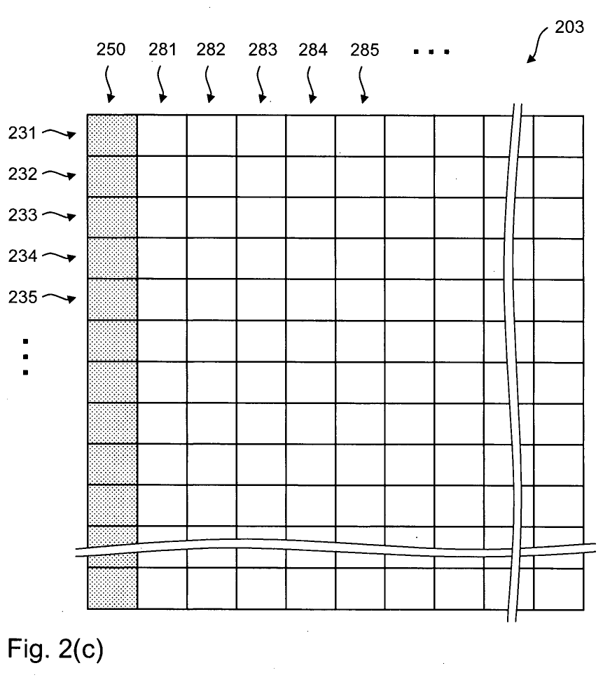

FIG. 2 schematically shows tables 201, 202, 203 of the database 12 implemented in the server computer system 1 according to the invention. Each row 211, 212, . . . ; 221, 222, . . . ; 231, 232, . . . of the tables 201-203 contains a tuple of data relating to a certain yarn package 93.

The first column 250 of the table 201 of FIG. 2(a) contains package identifiers uniquely identifying the respective yarn package 93. The second column 260 contains mill identifiers identifying the spinning mill 2 in which the respective package 93 was produced.

In the table 202 of FIG. 2(b), the first column 250 contains again the package identifiers uniquely identifying the respective yarn package 93. The second and subsequent columns 271, 272, . . . contain measured values for various yarn-quality parameters measured for yarn 92 on the respective yarn package 93.

Likewise, in the table 203 of FIG. 2(c), the first column 250 contains the package identifiers, whereas the second and subsequent columns 281, 282, . . . contain the further information on the respective yarn package 93.

In the embodiment of FIGS. 2(a)-(c), it is assumed that the package identifier is assigned biuniquely to each received set of measured values and to each received further information. Thus, the package identifiers in the first column 250 of each table 201-203 serve as a primary key for the database 12. The rows 211, 221, 231 of the different tables 201-203 containing data related to the same yarn package 93 are linked to each other by means of the package identifier in the first columns 250 of the rows 211, 221, 231.

In an alternative embodiment, other keys can be used for linking the rows of the tables of the database 12 to each other. For instance, package identifiers can be used that are unique within a spinning mill 2, but not within the whole database 12. In this case, the two columns 250, 260 of table 201, i.e., the package identifiers and the mill identifiers, are needed to jointly form a natural alternate key for the database 12. Other types of keys are also possible.

Turning again to FIG. 1, a buyer transmits from a client computer 8 via a global communication network 7 to the server computer system 1 a purchase request 71 containing yarn specifications. The purchase request 71 is received by the server computer system 1. The global communication network 7 for transmitting the purchase request 71 can be the same as or differ from the global communication network 6 for transmitting the measured values of yarn-quality parameters together with the further information.

Upon receipt of the purchase request 71, the server computer system 1 retrieves or filters from the database 12 sets of yarn packages. The further information stored in the database 12 must match the yarn specifications contained in the purchase request 71 for all packages 93 of each of the retrieved sets of yarn packages. Moreover, in embodiments with two or more spinning mills 2, the measured values must have been assigned the same mill identifier for all yarn packages 93 of the set of yarn packages, i.e., all yarn packages 93 of the set of yarn packages must have been produced by the same spinning mill 2.

If the database 12 does not contain any set of yarn packages that all match the yarn specifications, such sets of yarn packages whose further information approximates the yarn specifications are retrieved from the database 12. The person skilled in the art knows how to find such close sets of yarn packages. For instance, a metric can be defined in a vector space spanned by the parameters contained in the further information; distances between the parameters of the further information and the yarn specifications can be determined by means of the metric; and a measure for the distances, e.g., a least square mean, can be minimized.

The server computer system 1 produces a ranking of the retrieved sets of yarn packages 93. The ranking is based on the sets of measured values assigned to the yarn packages 93 of each set of yarn packages. The ranking can be on an ordinal scale or on a metric scale.

In the following, a ficticious example of producing a yarn-package ranking is given. Five retrieved sets of yarn packages A-E are considered, each having a yarn count of Ne 32. The number of five is merely exemplary and in no way limiting; in general, the server computer system 1 can retrieve any natural number of sets of yarn packages from the database 12. Table 1 lists mean values of five yarn-quality parameters that could be measured for each set of the yarn packages A-E.

TABLE 1

| | | | | | Neps, short |
|---|---|---|---|---|---|
| | | | | | and long |
| | Coefficient | | | | thick places, |
| | of mass | | Thick | | thin places |
| Set of yarn | variation | Neps per | places per | Thin places | (NSLT) per |
| packages | CVm | 100 km | 100 km | per 100 km | 100 km |
| A | 12.7 | 151 | 128 | 150 | 605 |
| B | 13.2 | 266 | 555 | 819 | 2254 |
| C | 14.4 | 1000 | 937 | 1582 | 2818 |
| D | 12.6 | 747 | 438 | 623 | 920 |
| E | 14.8 | 496 | 346 | 784 | 1680 |

Each mean value listed in Table 1 is assigned a corresponding percentile value indicating the position of the mean value within a large basic population of values of the same parameter. Such percentile values can be retrieved from the well-known USTER® STATISTICS, from the database 12 or from another compilation of quality parameter values. By definition, each percentile value lies within the range between 0 and 100. The lower the percentile value, the better the corresponding quality-parameter value compared to the basic population. Table 2 shows the percentile values a-e assigned to the mean values of Table 1.

TABLE 2

| | | | | | Neps, short |
|---|---|---|---|---|---|
| | | | | | and long |
| | Coefficient | | | | thick places, |
| | of mass | | Thick | | thin places |
| | variation | Neps per | places per | Thin places | (NSLT) per |
| Set of yarn | CVm | 100 km | 100 km | per 100 km | 100 km |
| packages | a | b | c | d | e |
| A | 23 | 15 | 16 | 9 | 12 |
| B | 52 | 22 | 60 | 56 | 78 |
| C | 81 | 83 | 79 | 80 | 84 |
| D | 16 | 46 | 47 | 38 | 33 |
| E | 95 | 31 | 54 | 51 | 60 |

A ranking r can be calculated, e.g., from the percentile values a-e of Table 2, according to the following formula:

r=9.179−(1.069·log a)−(0.807·log b)−(0.514·log c)−(0.822·log d)−(0.749·log e),

wherein the notation “log” denotes the common logarithm (to base 10). The higher the ranking r, the higher the quality of the set of yarn packages. The thus calculated ranking values r are listed in the second column of Table 3.

TABLE 3

| Set of yarn | | | | | |
|---|---|---|---|---|---|
| packages | Ranking r | Ranking r′ | Ranking r″ | Ranking r″′ | Ranking r″″ |
| A | 4.563 | 5 | ★★★★★ | 100 | 1 |
| B | 2.493 | 2 | ★★ | 60 | 3 |
| C | 1.609 | 2 | ★★ | 20 | 5 |
| D | 3.255 | 3 | ★★★ | 80 | 2 |
| E | 2.235 | 2 | ★★ | 40 | 4 |

Rankings other than the ranking r discussed above are possible. The formula for the ranking r given above is merely an example; the person skilled in the art is able to find other appropriate formulae. The ranking can take into account only one of the yarn-quality parameters or more than one of the yarn-quality parameters, combining them by means of arithmetical and/or logical operators. The calculation of the ranking can be based on percentile values as shown in Table 2 and/or directly on measured parameter values as shown in Table 1.

Table 3 gives examples of alternative rankings derived from the ranking r. A second ranking r′ in the third column is on a scale with natural numbers, whereas the ranking r is on a scale with rational numbers. The second ranking r′ can be derived by rounding the ranking r; moreover, it can be limited to a certain interval, e.g., to the natural numbers 1, 2, 3, 4, 5. The second ranking r′ may be simpler to grasp visually than the ranking r. However, such a simplification is at the expense of loss of information: in the example of Table 3, the sets of yarn packages B, C and E have the same second ranking values r′, although their original ranking values r are different.

A third ranking r″ in the fourth column of Table 3 corresponds to the second ranking r′ but represents the integer number by a corresponding number of graphical symbols, e.g., stars. Such a representation can be even simpler to grasp visually than the second ranking r′. The third ranking r″ can be interpreted as a classification system with five classes, each class being labelled by the corresponding number of stars. Each set of yarn packages A-E is classified into one of the classes.

A fourth ranking r′″ is on a scale with percentile values which indicate the position of the ranking value r within a sample consisting of, e.g., the sets of yarn packages A-E retrieved from the database 12. For instance, a fourth ranking of r′″=60 means that 60% of the sample have the same or lower ranking values r than the corresponding set of yarn packages B.

A fifth ranking r″ in the sixth column of Table 3 simply depicts the order of the ranking r, 1 denoting the highest ranking value r and 5 denoting the lowest ranking value r.

The rankings r, r′, and r″ are on metric scales, indicating differences between the values. In contrast, the rankings r′″ and r″″ are on ordinal scales.

The server computer system 1 transmits via the global communication network 7 to the client computer 8 of the buyer who sent the purchase request 71 information on a natural number of sets of yarn packages 93 best ranked in the produced ranking. This transmission is indicated by an arrow 72 in FIG. 1. The natural number of sets of best-ranked yarn packages 93 is preferably higher than one and lower than the number of retrieved sets of yarn packages. Thus, by means of the ranking, the server computer system 1 performs a quality filtering on the retrieved sets of yarn packages 93. The buyer 8 receives only information on high-ranked sets of yarn packages 93. Low-ranked sets of yarn packages 93, i.e., sets of yarn packages 93 of low quality, are filtered out of the retrieved sets of yarn packages 93 by not being transmitted to the buyer 8.

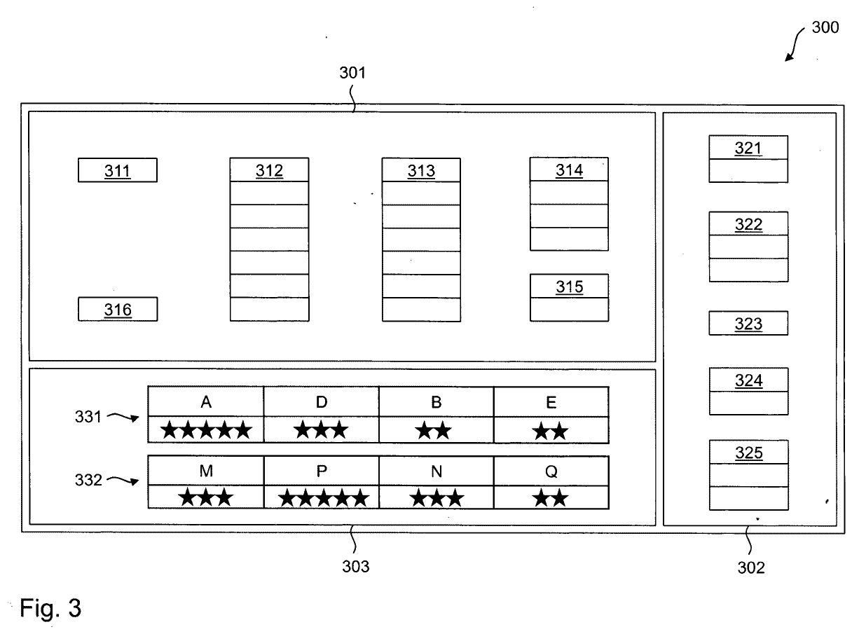

FIG. 3 shows an example of a user interface 300 outputted to a buyer by the client computer 8 on an output device, such as a display screen, connected to the client computer 8. The information displayed on the user interface 300 is based, at least in part, on the information transmitted from the server computer system 1 to the client computer 8. In the example of FIG. 3, the user interface 300 is divided into three areas 301-303.

A first area 301 is for important inputs by the buyer. Such essential inputs concern desired yarn characteristics, i.e., yarn specifications, and are preferably submitted with the purchase request 71. They overlap or coincide with the further information stored in the database 12 for each yarn package 93. They comprise, e.g., the following.
Yarn count 311, e.g., Ne 20, Ne 30, etc.;
Yarn material 312, e.g., cotton, polyester, viscose, modal, wool, etc.;
Fiber-processing system 313, e.g., carding or combing;
Spinning system 314, e.g., ring-spun yarn, compact yarn, rotor yarn, air-jet yarn, etc.;
Envisaged application 315, e.g., knitting or weaving; and/or
Desired amount 316 of yarn, e.g., 100 kg or 5000 km.

A second area 302 of the user interface 300 is for further inputs by the buyer. Such further inputs concern further information on the desired yarn. They can be submitted with the purchase request 71 and/or after receipt of information on the best-ranked yarn packages 93. They comprise, e.g., the following:
Temporal availability 321 of the yarn 92, e.g., deliverable within one week or within two weeks, etc.;
Desired price 322 of the yarn 92, e.g., 0-5 USD/kg, 5-10 USD/kg, etc.;
Supplier rating 323, e.g., a rating on a five-tier scale;
Preferred yarn suppliers 324; and/or
Preferred yarn brands 325.

A third area 303 of the user interface 300 is for outputs to the buyer. The outputs are transmitted from the server computer system 1 via the global communication network 7 to the client computer 8, the transmission being indicated by the arrow 72 in FIG. 1.

A primary output includes information 331 on a natural number of sets of yarn packages A, D, B, E best ranked in the produced ranking. In the example of FIG. 3, the natural number is four. The number of four is merely exemplary and in no way limiting; in general, the information 331 sent and outputted to the buyer can consist of any natural number of sets of yarn packages including zero. In accordance with the example of Tables 1-3, the four best-ranked sets of yarn packages A, D, B and E are outputted, whereas the worst-ranked set of yarn packages C is not. In the example of FIG. 3, the ranking 331 is in the form of graphical symbols as discussed above with reference to the fourth column (r″) of Table 3.

A further output in the third area 303 of the user interface 300 can be a spinning-mill ranking 332 of spinning mills M, P, N, Q supplying the sets of yarn packages A, D, B, E, respectively, ranked in the output 331. In the example of FIG. 3, the spinning-mill ranking 332 is in the form of graphical symbols, like the yarn-package ranking r″ discussed above with reference to the fourth column of Table 3. It is assumed that the four sets of yarn packages A, D, B, E are offered by four different spinning mills 2; however, the same spinning mill 2 could supply more than one set of yarn packages 93.

The example of FIG. 3 illustrates that the spinning-mill ranking 332 does not necessarily have to coincide with the yarn-package ranking 331. In the example, the spinning mill M that produced the best-ranked set of yarn packages A is not the best-ranked spinning mill. The best-ranked spinning mill P produced only the second-best-ranked set of yarn packages D. For instance, the yarn-package ranking 331 can be based on mean values of the measured quality-parameter values, whereas the spinning-mill ranking 332 can be based on coefficients of variation of the measured yarn-parameter values. Thus, the buyer can choose between the set of yarn packages A with the best mean parameter values, which, however, might have a large dispersion, and the set of yarn packages D with worse mean parameter values but a higher consistency. Of course, the buyer can as well choose the set of yarn packages B from spinning mill N or the set of yarn packages E from spinning mill Q, perhaps due to a significantly lower price and/or the yarn buyer's lower requirements related to yarn quality.

The ranking 331 of the sets of yarn packages and the ranking 332 of the spinning mills 2 facilitate the buyer's choice. The rankings 331, 332 are based on objective measurement values.

Still further information on the four sets of yarn packages A, D, B, E and/or on the spinning mills M, P, N, Q can be transmitted from the server computer system 1 to the client computer 8 and displayed to the buyer.

If the buyer is an end user of the yarn, the information received from the server computer system 1 (arrow 72 in FIG. 1) can constitute an offer from the spinning mill 2 to the buyer. After receipt of the offer 72, the buyer can choose one or several of the offered sets of yarn packages A, D, B, E and send a corresponding order from the client computer 8 via the global communication network 7 to the server computer system 1. Alternatively, the order can be placed via a buyer's enterprise-resource-planning system or a buyer's supply-chain-management system, which systems can be independent of the server computer system 1 according to the invention. The order identifies the chosen set or sets of yarn packages and indicates the ordered amount. The server computer system 1 receives the order and forwards it to the spinning mill 2 or spinning mills 2 that produced and offered the ordered set or sets of yarn packages; the forwarding of the purchase request is indicated in FIG. 1 by an arrow 62. The spinning mill 2 thereafter initiates a shipment of the ordered set of yarn packages to the buyer.

If, on the other hand, the buyer is an intermediary, it can forward the information received from the server computer system 1 to one or several of its customers (not drawn in FIG. 1), e.g., in form of an offer. The customer or customers can then place a purchase request via the intermediary and the server computer system 1 according to the invention or via an alternative route.

It is understood that the present invention is not limited to the embodiments discussed above. With knowledge of the invention, the person skilled in the art will be able to derive further variants which are also part of the subject matter of the present invention.

### LIST OF REFERENCE NUMERALS

1 Server computer system
11, 13 Communication means
12 Database
2 Spinning mill
3 Yarn-winding machine
31 Winding position
4 Yarn monitoring system
41 Yarn sensor
42 Data line
43 Yarn monitoring control unit
5 Cloud connector
6 Global communication network
61 Data transmission
62 Forwarding of purchase request
7 Global communication network
71 Purchase request
72 Information on best-ranked sets of yarn packages, offer
8 Client computer
91 Cop
92 Yarn
93 Yarn package
201-203 Tables of the database 12
211, 212, . . . . Rows of the first table 201
221, 222, . . . Rows of the second table 202
231, 232, . . . . Rows of the third table 203
250, 260 Columns of the first table 201
250, 271, 271, . . . . Columns of the second table 202
250, 281, 282, . . . Columns of the third table 203
300 User interface
301-303 Areas of the user interface 300
311 Yarn count
312 Yarn material
313 Fiber-processing system
314 Spinning system
315 Envisaged application
316 Desired amount of yarn
321 Temporal availability of yarn
322 Desired price of yarn
323 Supplier rating
324 Preferred yarn suppliers
325 Preferred yarn brands
331 Information on sets of yarn packages, yarn-package ranking
331 Spinning-mill ranking

1. A computer-implemented method for trading yarn packages (93) produced on yarn-winding machines (3) in at least one spinning mill (2), comprising the steps of:
receiving by a server computer system (1) via a global communication network (6) from a spinning mill (2) having produced a yarn package (93) on a yarn-winding machine (3) a set of measured values for at least one yarn-quality parameter measured for yarn (92) on the yarn package (93) by at least one sensor (41) on the yarn-winding machine (3) and further information on the yarn package (93);
assigning by the server computer system (1) to the set of measured values and to the further information a package identifier for the respective yarn package (93);
storing in a database (12) on the server computer system (1) the set of measured values, the further information and the assigned package identifier;
receiving by the server computer system (1) via a global communication network (7) from a client computer (8) a purchase request (71) containing yarn specifications;
retrieving from the database (12), using the package identifiers, sets of yarn packages such that the further information matches the yarn specifications for all packages of each of the retrieved sets of yarn packages;
producing by the server computer system (1) a ranking of the retrieved sets of yarn packages according to the sets of measured values assigned to the yarn packages of each set of yarn packages; and
transmitting from the server computer (1) system via the global communication network (7) to the client computer (8) information (71) on a natural number of sets of yarn packages best ranked in the produced ranking.

2. The computer-implemented method according to claim 1, wherein the set of measured values is for at least one parameter from the following set: coefficient of variation of the yarn mass, coefficient of variation of the yarn diameter, hairiness, number of thick places, number of thin places, number of periodic yarn defects, number of yarn count variations, number of foreign matters, number of splices.

3. The computer-implemented method according to claim 1, wherein the further information is from the following set: yarn count, yarn material, fiber processing system, spinning system, envisaged application, amount of yarn packages available, temporal availability of the yarn package, price of the yarn package.

4. The computer-implemented method according to claim 1, wherein the yarn specifications are from the following set: yarn count, yarn material, fiber processing system, spinning system, envisaged application, desired amount.

5. The computer-implemented method according to claim 1, wherein;
the database (12) is a relational database,
the package identifier is assigned uniquely to each set of measured values and to each further information, and
the package identifier is used as a key in the relational database (12).

6. The computer-implemented method according to claim 1, wherein the ranking is produced on an ordinal scale or on a metric scale.

7. The computer-implemented method according to claim 1, wherein the ranking is in the form of values calculated from the sets of measured values, in the form of quantiles or percentiles assigned to the sets of yarn packages, in the form of ordinal numbers assigned to the sets of yarn packages, or in the form of classes into which the sets of yarn packages are classified.

8. The computer-implemented method according to claim 1, wherein the ranking takes into account a mean value of each of the yarn-quality parameters calculated over the whole set of yarn packages.

9. The computer-implemented method according to claim 1, wherein the natural number of best-ranked sets of yarn packages is higher than one and lower than the number of retrieved sets of yarn packages.

10. The computer-implemented method according to claim 1, wherein an order is received by the server computer system (1) via the global communication network (7) from the client computer (8), the order identifying a chosen set or sets of yarn packages and indicating an ordered amount.

11. The computer-implemented method according to claim 10, wherein upon receipt of the order the server computer system (1) forwards it to the spinning mill (2) that produced the ordered set of yarn packages.

12. The computer-implemented method according to claim 1, further comprising the steps of:
receiving by the server computer system (1) via the global communication network (6) from the spinning mill (2) values of at least one ambient parameter characteristic for an ambient condition of a location and a time of winding the yarn package (93);
correcting by the server computer system (1) the set of measured values to predefined ambient conditions based on the values of the at least one ambient parameter, thus generating a set of corrected values; and
replacing in the method according to any one of the preceding claims the set of measured values by the set of corrected values.

13. The computer-implemented method according to claim 1, wherein the yarn packages (93) are produced in a plurality of spinning mills (2), further comprising the steps of:
assigning by the server computer system (1) to the set of measured values and to the further information a mill identifier for the respective spinning mill (2);
storing in the database (12) the assigned mill identifier; and
retrieving from the database (12), using the mill identifiers, the sets of yarn packages such that all yarn packages of each of the retrieved sets of yarn packages were produced by the same spinning mill (2).

14. A server computer system (1) comprising means for carrying out the method according to any one of the preceding claims.

15. A computer program having instructions which when executed by a server computer system (1) cause the server computer system (1) to perform the method according to any one of the claims 1-13.

16. A server computer system (1) for trading yarn packages (93) produced on yarn-winding machines in at least one spinning mill (2), comprising:
a receiver (11) for:
receiving via a global communication network (6) from a spinning mill (2) having produced a yarn package (93) on a yarn-winding machine (3) a set of measured values for at least one yarn-quality parameter measured for yarn (92) on the yarn package (93) by at least one sensor (41) on the yarn-winding machine (3), and
receiving via the global communication network (6) from the spinning mill (2) further information on the yarn package (93);
a processor for assigning to the set of measured values and to the further information a package identifier for the respective yarn package (93);
a memory for storing in a database (12) the set of measured values. the further information and the assigned package identifier;
a receiver (13) for receiving via a global communication network (7) from a client computer (8) a purchase request (71) containing yarn specifications;
a processor for retrieving from the database (12), using the package identifiers, sets of yarn packages such that the further information matches the yarn specifications for all packages of each of the retrieved sets of yarn packages;
a processor for producing a ranking of the retrieved sets of yarn packages according to the sets of measured values assigned to the yarn packages of each set of yarn packages; and
a transmitter (13) for transmitting via the global communication network (7) to the client computer (8) information on at least the set of yarn packages best ranked in the produced ranking.
